(19) United States
(12) Patent Application Publication
(10) Pub. No.: US 2022/0188736 A1
(43) Pub. Date: Jun. 16, 2022

(54) METHOD FOR IMPROVING LAW ENFORCEMENT ACCOUNTABILITY

(71) Applicant: Nathalie Colbert, Latham, NY (US)

(72) Inventor: Nathalie Colbert, Latham, NY (US)

(21) Appl. No.: 17/653,769

(22) Filed: Mar. 7, 2022

Related U.S. Application Data
(63) Continuation-in-part of application No. 16/834,215, filed on Mar. 30, 2020, now abandoned.
(60) Provisional application No. 62/825,246, filed on Mar. 28, 2019.

(51) Int. Cl. G06Q 10/06; G06Q 50/26; G06F 3/0481; G06F 16/29

(52) U.S. Cl. CPC G06Q 10/06398; G06F 16/29; G06F 3/0481; G06Q 50/26

(57) ABSTRACT

A method of improving navigation system by enabling users to collaboratively tracks and rate, through a navigation map, interactions between law enforcement and citizens and retrievably stores textual, video and audio output associated with the interaction as well as third-party data pertinent to accessing the professional conduct of law enforcement likely to be encountered in a mapped area.

### CROSS-REFERENCE TO RELATED APPLICATION

This application claims the benefit of priority of (a) U.S. provisional application No. 62/825,246 filed 28 Mar. 2019 and (b) U.S. nonprovisional application Ser. No. 16/834,215 filed 30 Mar. 2020 as a continuation in part, the contents of both are herein incorporated by reference.

### BACKGROUND OF THE INVENTION

The present invention relates to methods of improving law enforcement accountability and, more particularly, to a method of improving computer implemented GPS, navigation, and mapping systems for individuals fearful of biased, discriminatory, and/or unprofessional law enforcement methodologies.

When systemic bias is present in a police department and/or a police precinct, the impact to those who have interactions with the police of those departments and precincts can be, at the very least, unsettling.

Thus, there is a need for an improvement in GPS, navigation, and mapping applications for those who feel they may be treated unfairly by the police in a specific neighborhood or region they are passing through, visiting, or considering moving to. The inherent computer-based solution of improving the functioning of GPS, navigation, and mapping systems meets a long-felt need.

Satellite navigation software that provides turn-by-turn navigation information and user-submitted travel times and routes and similar GPS-enabled navigation and mapping applications are almost indispensable for individuals traversing new places. For some of these individuals the fear of receiving prejudicial treatment at the hands of the local police force of these new places, there is an identifiable and palpable interest in enabling those individuals with an awareness of the local sentiment toward the neighborhood police force and other relevant data that shines a light on the professionalism, courtesy and conduct of law enforcement when traveling to these new places.

The present invention embodies a method of improving law enforcement through pushing and pulling police conduct-related data through a navigation software that identifies police precincts and related police stations along the representative map of the navigation system. The present invention provides clickable icons for each police station or precinct, where the police conduct-related data may be pulled as well as pushed by users of the present invention. The police conduct-related data may be pushed and pulled as a function of the immutable identifier of police, their badge identification number. The present invention provides a navigation platform having a rating module, a forum module, and a dispatch module for effectuating the push and pull of such police conduct-related data for traveler/users of navigation software (that may be hosted by the navigation platform).

The pushed police conduct-related data can be transmitted by users, via the rating module, in the form of “intrinsic” police conduct-related data including interaction content collected by a user device when the user directly interacts with a police officer. The rating module may allow a user to further push or input a rating entry and/or answer questions (e.g., regarding police communication and response time) related to a submitted/pushed/inputted intrinsic police conduct-related data. The rating module may allow a user to associate a police badge identification with the interaction content and the rating entry.

The forum module allows users to push police conduct-related information in the form of forum content, i.e., information submitted by those residing in neighborhoods patrolled by police to whom this form of intrinsic police conduct-related information pertains. The forum module may allow a user to associate a police badge identification with the forum content, though forum content may not be associated with an individual badge identification numbers but rather may be more general precinct-related information.

The dispatch module pulls extrinsic police conduct-related data from third-party sources. The extrinsic police conduct-related data may include police communication information, for instance audio recordings of 911 calls, video recordings of police-vest cameras, and the like, as well as textual information from court documents or news agencies, or other third-party, non-user information that associates a badge identification number with each data set of extrinsic police conduct-related data.

The present invention may include a navigation platform with a networked server that identifies police precincts and police stations as navigation parameters that are represented on a navigation map via navigation software (hosted by the navigation platform of the present invention as a means of improving the navigation software). The platform server is configured to associate badge identification numbers with a relevant police station/precinct and thereby link the interactive content and intrinsic and extrinsic police conduct-related data (which each are critically associated with a badge identification number) with the relevant police station and the precinct by matching badge identification numbers. Accordingly, the pushed and pulled police conduct-related data is associated a navigation software parameter, which can be represented on and selectable through the navigation map. The present invention further links the forum content to the precinct parameters of the navigation software/system which are represented on the user-interface as the navigation map.

As a result, a user of the present invention may enter an address or general area into the navigation platform/system via a user interface of a computer/mobile device loaded with the software application embodying the present invention. The user interface represents a relevant navigation map, as well as indications of relevant police precincts and police stations, each of which may provide clickable icons. Icons selected by the users through their user interface, either enables the user to pull the interaction content, the forum content, and the intrinsic and extrinsic police conduct-related data for each representative parameter, wherein such data type/set is organizable by badge identification number. While traversing such areas, the user may, via the same clickable icons, generate relevant interaction content of police officers, via their mobile devices loaded with the systemic platform of the present invention, whereby the platform associates such pushed data with the badge identification number and from there with the relevant police station and precinct.

The platform may determine badge identification numbers associated with each precinct based on public records.

Police interactions can vary from community to community, even neighborhood to neighborhood. In some communities, the police can be improved by instilling accountability, which in turn fosters greater respect for law enforcement and, by extension, the rule of law.

As can be seen, there is a need for a rating system for law enforcement interactions aimed at improving communication between police and their communities through giving people access to quantifiable police-related data through a navigation map, wherein the police-related data enables users to evaluate the quality of the law enforcement in situ where they live or are interested in visiting. The police-conduct data and information accessible through an improved navigation application, enabling users to search different local law enforcement conditions quickly, “on the fly” as they are navigating to that locale all on the same user interface as the navigation map. In short, the rating system for law enforcement personnel gives their communities a method of applying accountability to peace officers, which to date is obscured by a lack of information and a code of silence, all through an improvement to navigation software via the systemic platform of the present invention.

### SUMMARY OF THE INVENTION

In one aspect of the present invention, a method and a system for improving a navigation software platform includes the following: a processor, and a memory comprising computing device-executable instructions that, when executed by the processor, cause the processor to implement: a navigation interface for accessing the navigation software platform over a network; a user interface for displaying and interacting with the navigation software platform, wherein the user interface populates the navigation software platform with one or more police parameters; a rating module for generating an interaction content associated with the one or more police parameter of the navigation software platform, wherein the interaction content comprises at least one of an image, an audio recording, and a video recording of at least one police officer and an intrinsically-associated badge identification number (BIN) for each officer; a forum module for adding a forum post associated with the one or more police parameter; and a dispatch module for generating an extrinsic data associated with the one or more police parameter wherein the extrinsic data comprises at least one of a police-vest video recording and a police dispatch audio recording, wherein each extrinsic data has an extrinsically-associated BIN. The police dispatch may be a communication between a police officer and their dispatcher for that police officer's police department.

In another aspect of the present invention, the method/system for improving a navigation software platform further includes the following: wherein each of the police parameters provides an icon, via the user interface, on a navigation map of the navigation software platform, wherein the icon is configured to enable access to the each interaction content, forum post, and extrinsic data, wherein the icon is configured to list each interaction content and extrinsic data by the respective associated BIN, wherein the rating module prompts the user interface to display a record button and a text input, wherein selecting the record button records a live video feed for capturing interaction content, and wherein inputting the text input overlays the inputted text on the interaction content, wherein the inputted text is a BIN, wherein the live video feed is enabled with a BIN-recognition software, wherein the BIN is a badge number.

These and other features, aspects and advantages of the present invention will become better understood with reference to the following drawings, description and claims.

### BRIEF DESCRIPTION OF THE DRAWINGS

FIG. 1A is schematic view of a computing device of an exemplary embodiment of the present invention.

FIG. 1B is a schematic view of a network of computing devices of an exemplary embodiment of the present invention.

FIGS. 2A-2C are charts of an exemplary embodiment of the present invention.

FIG. 3 is a schematic view of a navigation map of an exemplary embodiment of the present invention.

FIG. 4 is a diagrammatical view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The present invention includes a method of improving the performance of inherently computer-implemented GPS navigation and mapping software system that allows users to evaluate and provide indications of the quality of law enforcement in the areas search through the navigation system. The platform embodied in the present invention enables users to push and pull textual, video, and audio interaction content as well as rate the interaction content they generate through a rating module. As a result, the platform enables users to collaboratively create a mosaic of police conduct-related data and information for a particular police officer and by extension an entire police station and greater precinct. The police conduct data may be linked to all the above through an immutable unique identifier associated with each police officer—the police officer's badge number.

The present invention allows users (through a forum module) to direct other users to create contextual forum content of police-conduct information, e.g., wherein users within an area of a police precinct may be prompted to discuss what is going on in their community and current event that are related to the performance of a police precinct and/or police officer. These users can upload videos, pictures, and make posts, review an event, provide suggestions on certain topics, and the like. In some embodiments, the GPS of a user of the forum module may limit uploading of forum content related to police stations/precincts/navigation map parameters that are within a predetermine vicinity of those police stations/precincts/navigation map parameters.

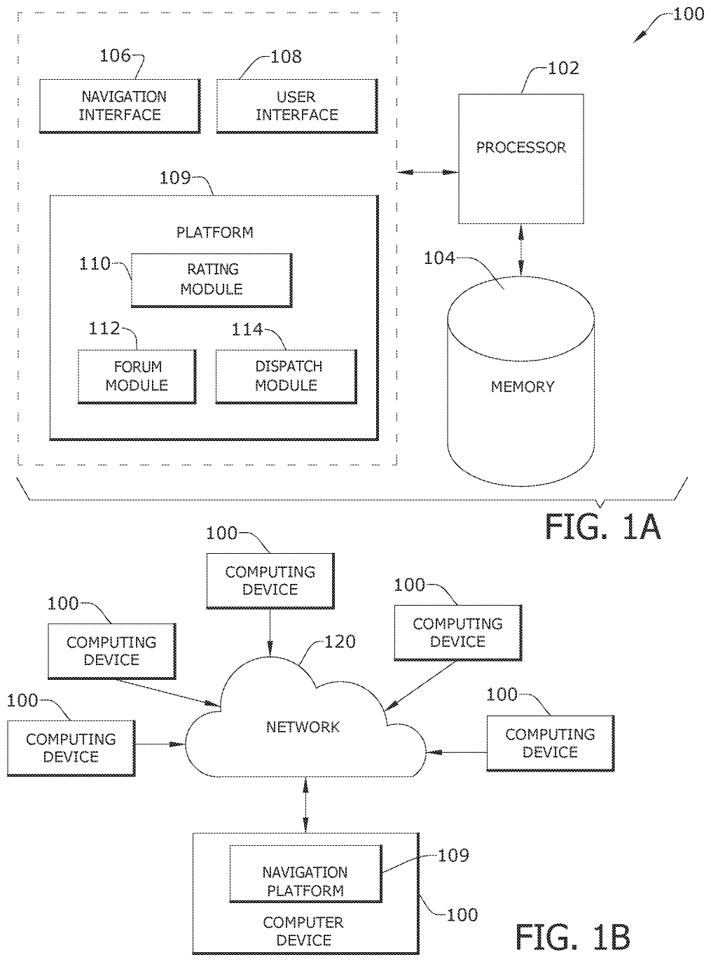

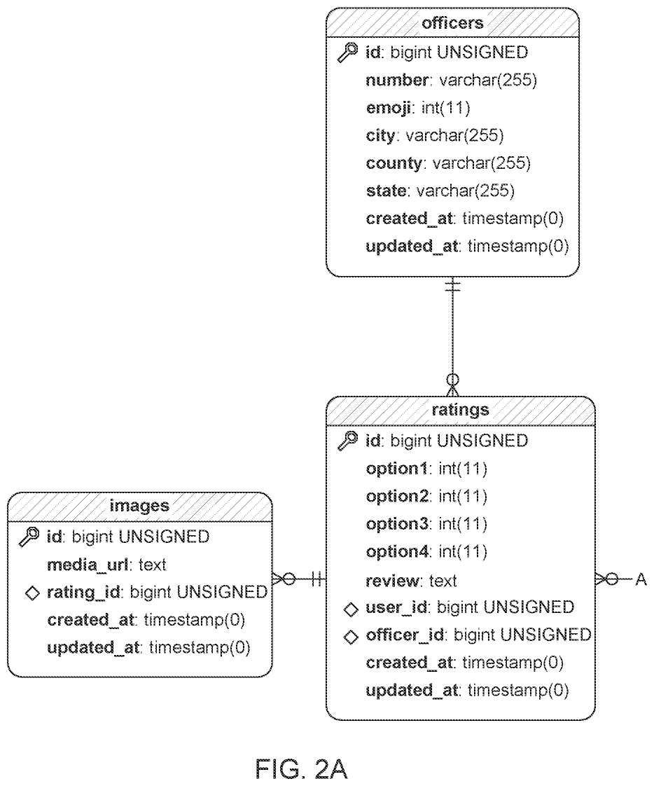

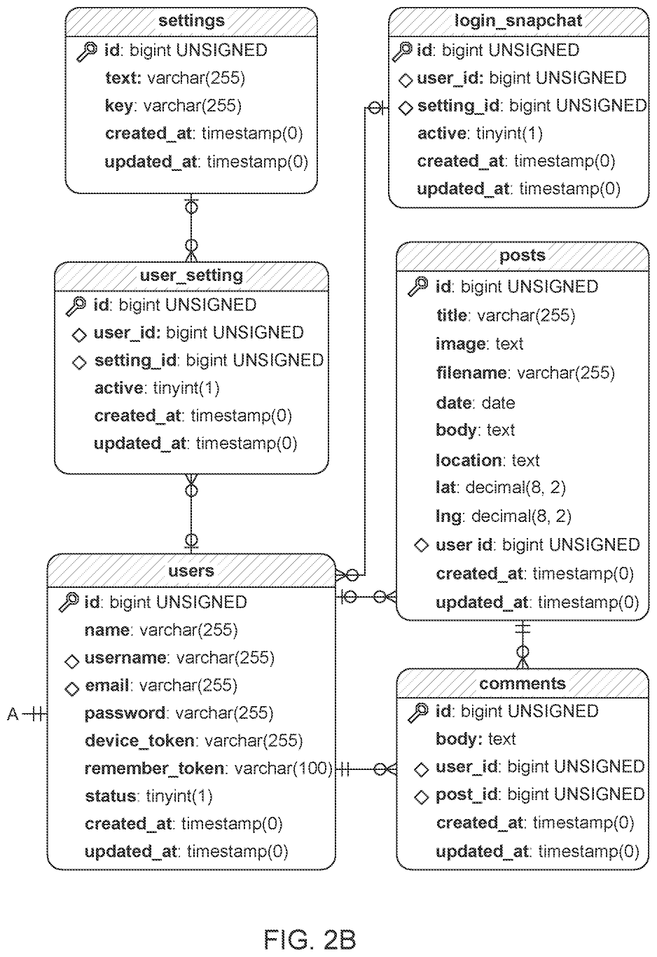

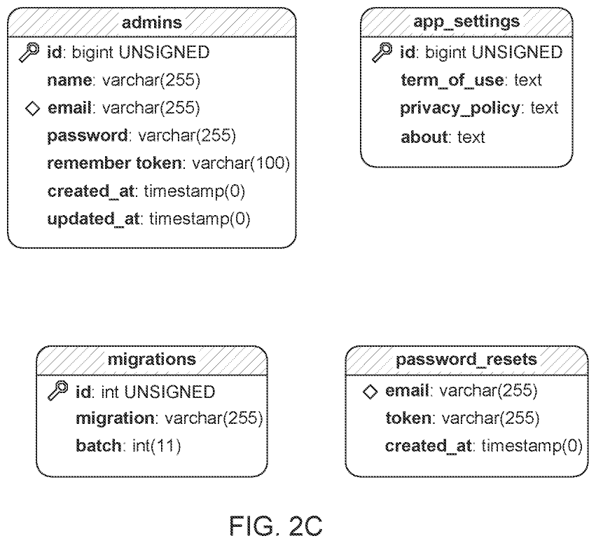

Referring to FIG. 1, the present invention includes a system of virtual collaboration. The system includes at least one computing device 100 having a processor 102 and a memory 104. The memory 104 includes software in the form of computing device-executable instructions that, when executed by the processor, cause the processor to implement: a communications interface 106, a user interface 108, and a navigation platform 109. The navigation platform 109 includes, but is not limited to, a rating module 110, a forum module 112, and a dispatch module 114.

The computing device 100 is at least the processor 102 and the memory 104. The computing device 100 may include a smart phone, a tablet computer, a laptop, a desktop, and the like. The computing device 100 may execute on any suitable operating system such as IBM's zSeries/Operating System (z/OS), MS-DOS, PC-DOS, MAC-iOS, WINDOWS, UNIX, OpenVMS, ANDROID, an operating system based on LINUX, or any other appropriate operating system, including future operating systems.

In particular embodiments, the computing device 100 includes the processor 102, the memory 104, the user interface 108, and the navigation interface 106. In particular embodiments, the processor 102 includes hardware for executing instructions, such as those making up a computing device program. The memory includes main memory for storing instructions such as computing device program(s) for the processor to execute, or data for processor to operate on. The memory may include an HDD, a floppy disk drive, flash memory, an optical disc, a magneto-optical disc, magnetic tape, a Universal Serial Bus (USB) drive, a solid-state drive (SSD), or a combination of two or more of these. The memory 104 may include removable or non-removable (or fixed) media, where appropriate. The memory 104 may be internal or external to the computing device 100, where appropriate. In particular embodiments, the memory 100 is non-volatile, solid-state memory.

The user interface 108 is for displaying and interacting with the navigation platform 109. The user interface 108 includes hardware, software, or both providing one or more interfaces for user communication with the computing device. As an example, and not by way of limitation, the user interface 108 may include a keyboard, keypad, microphone, monitor, mouse, printer, scanner, speaker, still camera, stylus, tablet, touchscreen, trackball, video camera, another user interface or a combination of two or more of these.

The communications interface 106 is for accessing a navigation platform 109 over a network 120. The navigation interface 106 includes hardware, software, or both providing one or more interfaces for communication (e.g., packet-based communication) between the computing device 100 and one or more other computing devices 100 on one or more networks 120. As an example, and not by way of limitation, navigation interface 106 may include a network interface controller (NIC) or network adapter for communicating with an Ethernet or other wire-based network or a wireless NIC (WNIC) or wireless adapter for communicating with a wireless network, such as a WI-Fl network. This disclosure contemplates any suitable network and any suitable navigation interface 106. As an example, and not by way of limitation, the computing device 100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks 120 may be wired or wireless. As an example, the computing device 100 may communicate with a wireless PAN (WPAN) (e.g., a BLUETOOTH WPAN), a WI-Fl network, a WI-MAX network, a cellular telephone network (e.g., a Global System for Mobile Communications (GSM) network), or other suitable wireless network or a combination of two or more of these. The computing device 100 may include any suitable communication interface 103 for any of these networks 120, where appropriate.

The navigation platform 109 may include a standalone software program, such as a social media program or an e-collaboration program. The standalone program may include a plurality of different user's that create profiles with identifying pictures, videos, personal data, and the like. Alternatively, the navigation platform 109 may include an application programming interface (API) plugin as a police conduct-related data plugin tool that agnostically integrates such push/pull features into already existing software platforms, web servers, and mobile based navigation platforms. The API plugin may integrate the police conduct related push/pull features (rating, forum, and dispatch modules) described in more detail herein into existing navigation platforms, as well as news platforms, media platforms, blog platforms, product and service website platforms, and the like to enable incorporating the rating, forum, and dispatch modules into navigation software supported by those navigation platforms.

As a standalone communication software program, the navigation platform 109 may include a main page and a plurality of individual user profile pages. The main page may include a news feed, and each of the plurality of user profile pages may include a user's picture, video, and shared user personal data. The navigation platform may identify and enable particular “service users”, for instance providers of legal services. Service users and users may view each other's profile pages, engage in messaging via a message portal, so that users can find and make inquires to such service users. Services users may be, but are not limited to, legal service provider, such as attorneys, law firms, investigators, and the like.

The navigation platform 109 supports a rating module 110, a forum module 112, and a dispatch module 114 as a standalone software program or as an API plugin.

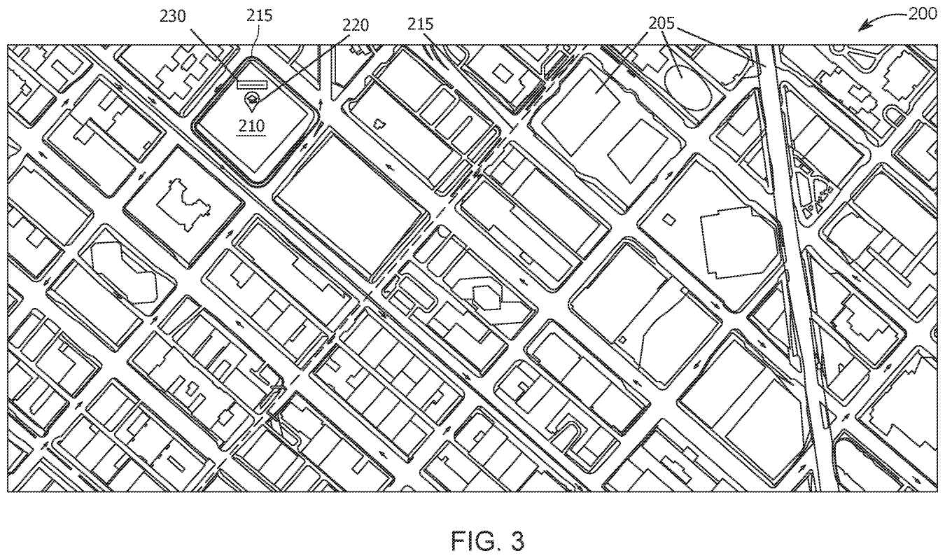

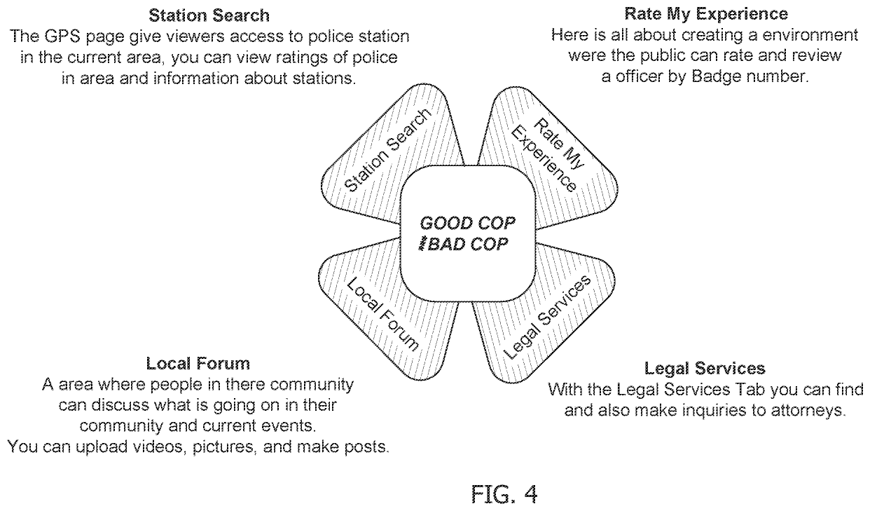

The navigation interface 106 is for generating or coupling with a pre-existing navigation system used to calculate a preferred route that can represent the navigation route for travel from a starting point to a destination for meeting the target arrival time, as known in the art, while adding the rating, forum, and dispatch modules disclosed herein. As a result, navigation system of the present invention is enabled to represent map 200 with a surrounding landscape, including structures and buildings in a cityscape or other parameters 205. The navigation system can further represent the route and surrounding map parameters 205, such as the landscape or the cityscape on the user interface 108, as illustrated in FIG. 3.

The rating module 110 is adapted to further identify specific police parameters 210 of the surrounding map parameters, including representing identification of the police parameter 210 and associated data related to an identifier 215. For instance, a specific parameter may be a police precinct and relevant police stations within the police precinct. By way of an example, a police precinct may be denoted by an identifier 215, such as a boundary line, as illustrated in FIG. 3. A police station may also be denoted by some form of highlighting identifier 215, as also identified in FIG. 3.

Associated parameter data (such as the push/pull police conduct-related data and information disclosed herein) may take the form of an icon 220 that is clickable/selectable to access a database of the associated parameter data. The associated parameter data may include a representative “snapshot” 230 of the associated police-conduct data. The snapshot 230 may include a rating, as well as such as a list of searchable and selectable police-conduct data disclosed in more detail below.

Clicking on the parameter data icon 220 of the representative snapshot 230 may include an instruction, prompt, or request for one or a plurality of types a post, including a forum content post or to rate an experience related to the underlying parameter (e.g., police precinct or police stations). Forum content may be a post by a user discussing a specific law enforcement actor or a precinct. The selection of the forum content or rating options may also prompt the user, via the user interface 108, to input identifying textual information associated with the forum content or rating content. The rating content may be generated in response to questions regarding the performance of a police officer, such as but not limited to providing a rating of the following: response time; communication; attitude; professionalism; overall experience

All of the associated parameter data found through selecting the icon 220 and/or the representative snapshot 230 associates a badge identification number (BIN) of a law enforcement individual whose actions are being discussed in the forum content and rating content. This inputted BIN may be overlaid on the resulting forum content, rating content or any of the police conduct-related date retrievable stored in said database and associated with the parameters (e.g., police precincts) of the navigation map 200 and retrievable through selecting the icon 220 and/or the representative snapshot 230.

Clicking on the icon 220 may provide access to a database (associated with the memory 104) listing all associated law enforcement personnel by their identifier. In certain embodiments, the identifier may be a badge identification number (BIN) of a law enforcement individual whose actions are being discussed in the forum content.

The rating module 110 may include Interaction Output (IO) functionality that enables users to create a post of interaction output. IO may offer different template formats for users to utilize. For example, the template formats may include, but are not limited to, audio, video, captured images, and the like. These template formats may be coupled to recording device of a mobile device loaded with the present invention, so that the recording devices are configured to record an audio recording, a captured image and/or video, as well as text-based inputs (keyboard, voice commands) to enter a BIN associated with the captured content, thereby providing an audio and/or video recording of real time data.

The rating module 110 enables adding interactive content to the police rating collaboration via the IO. The interaction content is original content that may be created at the time of the creation of the interaction output post. In certain embodiments, the rating module 110 prompts the user interface 108 to display a record button, a live video feed taken by a video camera. The user may select the record button, which records the live video feed to generate the interaction output post. Audio and captured image-related interaction output can be similarly created through first a prompt from the rating module 110. A plurality of different users may generate the interaction output on one event, which are posted to the navigation platform and represented on the map 200. The selection of the record button may also prompt the user to input identifying textual information, this inputted text may be overlaid on the resulting live video feed. The identifying textual information may be an identifier of individuals captured by the live video feed (or captured image or audio capture), wherein the interaction output is associated with that identifier. The rating module 110 may retrievably store (in a database/memory 104) the interaction content as a function of the identifier.

The BIN may alternatively be identified directly from the captured video or image of the interaction content itself. Known software, akin to facial recognition software, may be employed on the interaction content to glean a BIN that is captured in said content.

Each BIN, through previously stored data, may be associated with parameters (e.g., police precincts) identified on the navigation map 200. As a result, the navigation platform may receive a BIN (extrinsically through the identifier prompt or intrinsically through scraping it directly from the interactive content itself) associate it with a police precinct/parameter of the navigation map 200 and make it part of the associated parameter data (and accessible through the icon 220 or snapshot 230) that a user of the navigation map can select and clickably retrieve when navigating the map 200. Similarly, the informational data may also include access to specific interactive content (by way of the BIN) associated with that parameter/police precinct.

The dispatch module 114 is for linking extrinsic BIN-related dispatch data to the parameters of the navigation map 200. The extrinsic BIN-related dispatch data may include police communications, including audio of 911 operators, police dispatches and the like. Video (and audio) output may be output captured by a police vest, police vehicle, a third-party surveillance device. Textual information may include the police and or third-party summaries of the interaction (such as a journalist's report). The extrinsic BIN-related dispatch data includes any data that has a BIN associated thereto.

The extrinsic BIN-related dispatch data can be pulled from third-party sites accessible over the internet, wherein the extrinsic BIN-related dispatch data may be retrievably stored by the navigation platform as well as map parameters and its clickable icon.

A method of improving a navigation system may include the following steps. Produce, via software running on a plurality of computing devices, a navigation platform, wherein the plurality of computing devices is connected by a network 120. Generate, via the software running on a first computing device of the plurality of computing devices, a navigation map on the mapping platform, the navigation map including a police parameter (e.g., a police station) having at least one of a badge identification number (BIN) associated thereto, wherein the BIN has an associated interaction content. For each BIN, generate and add, via the software running on a plurality of different second computing devices of the plurality of computing devices, one or more rating or forum posts associated with the BIN. Each BIN further has an extrinsic police conduct data pulled in from third-party source. Display, via the software running on at least one of the plurality of computing devices, a record button and an overlay of a prompt for entering a BIN on the live video feed. Selecting the record button and records the live video feed, and then entering the BIN which becomes overlaid text to the newly-generated interaction content. Generate, via the software running on the plurality of computing devices, a string of interaction content that is retrievable through a navigation map 200 icon 220 or snapshot 230.

It should be understood, of course, that the foregoing relates to exemplary embodiments of the invention and that modifications may be made without departing from the spirit and scope of the invention as set forth in the following claims.

What is claimed is:

1. A system for improving a navigation software platform comprising:
a processor, and
a memory comprising computing device-executable instructions that, when executed by the processor, cause the processor to implement:
a navigation interface for accessing the navigation software platform over a network;
a user interface for displaying and interacting with the navigation software platform, wherein the user interface populates the navigation software platform with one or more police parameters;
a rating module for generating an interaction content associated with the one or more police parameter of the navigation software platform, wherein the interaction content comprises at least one of an image, an audio recording, and a video recording of at least one police officer and an intrinsically-associated badge identification number (BIN) for each officer;
a forum module for adding a forum post associated with the one or more police parameter; and
a dispatch module for generating an extrinsic data associated with the one or more police parameter wherein the extrinsic data comprises at least one of a police-vest video recording and a police dispatch audio recording, wherein each extrinsic data has an extrinsically-associated BIN.

2. The system of claim 1, wherein each of the police parameters provides an icon, via the user interface, on a navigation map of the navigation software platform, wherein the icon is configured to enable access to the each interaction content, forum post, and extrinsic data.

3. The system of claim 2, wherein the icon is configured to list each interaction content and extrinsic data by the respective associated BIN.

4. The system of claim 3, wherein the rating module prompts the user interface to display a record button and a text input, wherein selecting the record button records a live video feed for capturing interaction content, and wherein inputting the text input overlays the inputted text on the interaction content, wherein the inputted text is a BIN.

5. The system of claim 4, wherein the live video feed is enabled with a BIN-recognition software.

6. The system of claim 5, wherein the BIN is a badge number.
